(19) United States
(12) Patent Application Publication
(10) Pub. No.: US 2025/0183818 A1
(43) Pub. Date: Jun. 5, 2025

(54) POWER SMOOTHING AND BOOSTING FOR EXERCISE MACHINE

(71) Applicant: CONFIGURABLE FITNESS, LLC, Casper, WY (US)

(72) Inventors: Shemuel EZRAN, Beverly Hills, CA (US); Casey HANLON, Aberdeen, MS (US); Stephen ABEL, Chandler, AZ (US); Michael MARGOLESE, Las Vegas, NV (US); John SANCHEZ, Mesa, AZ (US); Yosef D. AFRIAT, Scottsdale, AZ (US)

(73) Assignee: CONFIGURABLE FITNESS, LLC, Casper, WY (US)

(21) Appl. No.: 18/839,287

(22) PCT Filed: Feb. 16, 2023
(86) PCT No.: PCT/US2023/062734

§ 371 Date: Aug. 16, 2024

Related U.S. Application Data
(60) Provisional application No. 63/311,931, filed on Feb. 18, 2022.

(51) Int. Cl. H02P 4/00; A63B 21/005; A63B 24/00

(52) U.S. Cl. CPC H02P 4/00; A63B 21/0054; A63B 21/0058; A63B 24/0087

(57) ABSTRACT

An electro-mechanical system including a power supply, at least one energy storage device and at least a boost circuit, in which the power supply is directly connected to an AC power source and the at least one energy storage supplies power to an electro-mechanical device and its controller. The boost circuit transfers excess power not being used at any given time into the energy storage device to provide an increase in available power comes. This increase in available power stabilizes the power delivery and improves the operation of the device. The device can include at least one motor and at least one motor controller and at least one buck circuit. The power supply, the at least one energy storage and the at least one motor controller can be connected in series.

### BACKGROUND OF THE INVENTION

### 1. Field of Invention

The present invention is directed to an energy storage system for a device that is electrically connected to an alternating current (AC) power (or direct current (DC) power source), such as the commercial or residential power distribution grid, that utilizes a series connection between a power supply, that is directly connected to the AC (or DC power source), an energy storage device, and the energy storage device provides power directly to a motor controller, which in turns drives the motor.

### 2. Description of the Background Art

The prior art method for providing power to a motor of a device includes providing a parallel connection between a power supply connected to AC power source (or DC power source) and a motor controller, in which an energy storage device is used to supplement the AC power source from the power supply. For instance, U.S. Pat. No. 10,792,539, herein “Gilstrom et al.,” discloses a standard AC input 243, a power supply 242, a main power rail 246 connected to a motor controller 104 and a power management module 202 (Gilstrom et al. FIG. 2A and column 7 lines 23-55). Further, Gilstrom et al. discloses that the energy storage device 204 stores energy to “boost the available power to be able to drive multiple high power motors (106) to their full peak force” (Gilstrom et al. column 7, lines 37-40). However, this parallel connection in Gilstrom et al. between the power supply and the motor controller can cause unstable and unreliable power supply to the motor. Therefore, there is a need to provide stable power supply to a motor of a device.

Devices, including digital strength training devices that utilize motors or other devices to provide a resistive force to a user, can have energy requirements that exceed a typical 110V-115V electrical outlet found in the US (i.e., via a utility service provider). Therefore, such digital strength training devices can generally require a 220V outlet to operate properly, which are commonly used to provide energy for stoves, air conditioners, dryers, and the like. However, 220V outlets can not be located in a room where the digital strength training device is located (or to be located in). Therefore, there is a need to boost the power available to a driven motor or power consuming mechanism, from an AC power source, by storing unused power in the energy storage device, thereby increasing the power available to the motor. This unused power can come from the AC power source or regenerative power from the load motor or motors while in a regeneration mode. That is, the present invention provides enough energy to drive digital strength training devices in a stable and reliable manner.

### SUMMARY OF THE INVENTION

The present invention is directed to provide stable and reliable power to a device that can exceed the power available from a standard 110V outlet (typically limited to 1500 w), utilizing a novel circuit between an AC circuit, an energy storage system, and a controller of a device and to provide a smooth motor operation to the user.

The device can be any type of electromechanical (EM) device, such as motor-based resistance exercise machine, a welding apparatus, a robotic motion control, and the like, but is not limited thereto.

In the case of a motor-based exercise machine, the system of the present invention provides greater resistance forces and/or speeds than otherwise possible from the same motor and utility service without the current invention, due to an increase in the available power to the motor of the exercise machine by the system.

The present invention utilizes an energy storage system that can comprise a secondary battery, a capacitor, a supercapacitor, hybrid supercapacitor, or a mechanical system to store energy for providing power to at least one motor controller of at least one motor. Secondary batteries include but are not limited to lead-acid batteries, nickel-cadmium batteries, nickel-iron batteries, nick-metal hydride batteries, lithium-ion batteries, lithium-ion polymer batteries. Further, secondary batteries can include a liquid electrolyte or a solid electrolyte. Another implementation is that when the energy storage bank includes a supercapacitor plus battery, our system allows for the exercise device, or other electro-mechanical device, to be used even with the plug disconnected from the wall alternating current (AC) power.

The present invention is directed to an EM system that provides bi-directional energy flow to the device and can involve a series electrical connection between a power supply and at least one energy storage/reservoir and/or a series electrical connection between a motor and the at least one energy storage.

The present invention provides control stability of power supplied to a device, such as an electro-mechanical device, which can be operated by a user, to improve operation of the device, such as smoothness, feel and stability during use of the device.

The present invention can utilize a buck circuit (i.e., buck converter) and a boost circuit (i.e., boost converter), only a boost circuit, or only a buck circuit, to provide an operating voltage of the device that is different (e.g., higher) than a voltage of the AC power input. This system can be deemed a step-up power regulator system, or the like. The buck circuit and the boost circuit provide a stable source of power to a motor of a device (e.g., EM device), which can be providing motor-based resistance to the user or a device being manipulated.

An electromechanical (EM) system according the present invention can include an energy storage device supplying power to a device; and a power supply connected to an alternating current (AC) power source and supplying energy to the energy storage device. Only the energy storage device supplies energy to the device. That is, the power supply is not directly connected to the device, but is connected to the device through the energy storage device, such that the energy storage device directly supplies energy to the device. The energy storage device is capable of supplying energy to the device greater than energy supplied from the power supply alone, and the energy storage device is further capable of providing power to the device with less ripple voltage and less ripple current than power provided from the power supply alone.

The system according to the present invention can further include the device, and the device is an electromechanical (EM) device, and the EM device generates energy when work is applied to the EM device.

The system according to the present invention can further include a regeneration regulator connected to the EM device. The regeneration regulator captures energy generated by the EM device and transfers the generated energy to the energy storage device when the work applied to the EM device exceeds a predetermined threshold.

The system according to the present invention can further include a motor regulator that maintains a voltage of a motor controller of the device and a bus voltage of the motor to prevent an over/under voltage of the motor controller and to exceed motor back electromotive force (EMF) and the regeneration regulator is connected between the motor and the motor regulator, and discharges energy from the motor to the motor regulator.

The system according to the present invention can further include a supercapacitor charger between the power supply and the energy storage device, the supercapacitor charger including a current sensor, a voltage sensor, a microcontroller connected to the current sensor and to the voltage sensor, and an OR-ing controller connected to the regeneration regulator and to the power supply and enables DC power from the power supply and power from the regeneration regulator to charge the energy storage capacitor simultaneously.

The regeneration regulator can be a logic-controlled buck converter connected to the energy storage device and to a motor of the device, and the logic-controlled buck converter regulates and transfers regenerative energy from the motor to the energy storage device to recharge the energy storage device and so the regenerative energy does not cause a bus voltage of the device to exceed a maximum voltage acceptable to a motor controller of the device.

The system according to the present invention can further include the device, the device can include an actuator, a motor and a motor controller configured to control the motor of the device and The system according to the present invention can further include a boost converter connected between the motor controller and the energy storage device. The boost converter increases an output of the energy storage device to increase power available to the motor.

The system according to the present invention can further include a buck converter connected to the energy storage device and the motor of the device. The buck converter can regulate and transfer regenerative energy from the motor to the energy storage device so the regenerative energy does not cause a bus voltage of the device to exceed a maximum voltage acceptable to the motor controller of the device.

The system according to the present invention can further include the device. The device can include a motor controller configured to control a motor of the device and a motor regulator connected between a motor of the device and the energy storage device. The motor regulator can maintain a voltage of the motor controller of the device and a bus voltage of the motor to prevent an over/under voltage of the motor controller and to exceed motor back electromotive force (EMF).

The system according to the present invention can further include an energy storage regulator between the power supply and the energy storage device. The energy storage regulator can be a DC/DC voltage or current regulator that regulates power into the energy storage device.

The energy storage device can be a first energy storage device among a plurality of energy storage devices of the system, and the plurality of energy storage devices can be connected in series.

An electromechanical (EM) system according the present invention can include a plurality of energy storage devices, the plurality of energy storage devices being connected to each other in series, a power supply connected to an alternating current (AC) power source and supplying energy to the plurality of energy storage devices, and a motor regulator increasing an output of the plurality of energy storage devices to increase power available to motors of a plurality of electromechanical (EM) devices arranged in parallel such that the boosted output of the plurality of energy storage devices supports desired torque-speed requirements of the plurality of EM devices. A first bus voltage on a first side of the plurality of energy storage devices can be different than a second bus voltage on a second side of the plurality of energy storage devices, and only the plurality of energy storage devices supply energy to the plurality of EM devices.

The system according to the present invention can further include a regeneration regulator on an output of the plurality of EM devices to capture regenerative energy and to transfer the regenerative energy into the plurality of energy storage devices so that the second bus voltage does not exceed a predetermined maximum amount.

The system according to the present invention can further include an energy storage regulator connected between the power supply and the plurality of energy storage devices, the energy storage regulator being a DC/DC voltage or current regulator that regulates power into the plurality of energy storage devices.

The system according to the present invention can further include the plurality of devices. Each of the plurality of devices includes an actuator, a motor and a motor controller that controls the motor of the device. The motor regulator can be a boost converter.

An electromechanical (EM) system according the present invention can include an energy storage device supplying power to a device, a power supply connected to an alternating current (AC) power source and supplying energy to the energy storage device, an energy storage regulator connected between the energy storage device and the power supply, the energy storage regulator including a current sensor and a voltage sensor, and a logic-controlled regeneration regulator connected to the energy storage device and to a motor of the device. The logic-controlled regulator controls a feed-forward charge of the energy storage device to ensure that the energy storage device retains an optimal charge condition, and only the energy storage device is supplies energy to the device.

The system according to the present invention can further include a motor controller controlling a motor of the device and a boost converter connected between the motor controller and the energy storage device. The boost converter increases an output of the energy storage device to increase the power available to the motor.

The regeneration regulator captures and regulates energy produced by the device when work is applied to the device, and the energy storage device is simultaneously charged from the power supply and from the regenerative energy regulator.

The system according to the present invention can further include a motor controller controlling a motor of the device, and a motor regulator connected between a motor of the device and the energy storage device. The motor regulator maintains a voltage of the motor controller of the device and a bus voltage of the motor to prevent an over/under voltage of the motor controller and to exceed motor back electromotive force (EMF).

The energy storage device can be a first energy storage device among a plurality of energy storage devices of the system, and the plurality of energy storage devices can be connected in series.

Further scope of applicability of the invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

The present invention will become more fully understood from the detailed description given hereinbelow and the accompanying drawings which are given by way of illustration only, and thus are not limitative of the present invention, and wherein:

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is an illustration of a system according to an embodiment of the present invention.

FIGS. 2A and 2B are illustrations of systems according to an embodiment of the present invention including a power supply, energy storage device(s) and without an energy storage regulator and without regenerative charging. In FIG. 2B, the actuators are connected in parallel.

FIG. 3 is an illustration of a system according to an embodiment of the present invention including a power supply, energy storage device(s), regenerative charging and without an energy storage regulator.

FIG. 4 is an illustration of a system according to an embodiment of the present invention including a power supply, energy storage device(s) and an energy storage regulator and without regenerative charging.

FIG. 5 is an illustration of a system according to an embodiment of the present invention including a power supply, energy storage device(s), an energy storage regulator and regenerative charging.

FIG. 6 is an illustration of a system according to an embodiment of the present invention including a power supply, energy storage device(s) and a motor regulator.

FIG. 7 is an illustration of a system according to an embodiment of the present invention including a power supply, energy storage, a motor regulator and regenerative charging.

FIG. 8 is an illustration of a system according to an embodiment of the present invention including a power supply, energy storage device(s), at least one boost converter, and without regenerative charging.

FIG. 9 is an illustration of a system according to an embodiment of the present invention including a power supply, energy storage device(s), boost converter(s) and regenerative charging.

FIG. 10 is an illustration of a system according to an embodiment of the present invention including a power supply, energy storage device(s), an energy storage regulator, a motor regulator and without regenerative charging.

FIG. 11 is an illustration of a system according to an embodiment of the present invention including a power supply, energy storage device(s), an energy storage regulator, a motor regulator and regenerative charging.

FIG. 12 is an illustration of a system according to an embodiment of the present invention including a power supply, energy storage device(s), an energy storage regulator, at least one boost converter and without regenerative charging.

FIG. 13 is an illustration of a system according to an embodiment of the present invention including a power supply, energy storage device(s), an energy storage regulator, at least one boost converter and regenerative charging.

FIG. 14 is an illustration of a system according to an embodiment of the present invention including a power supply, energy storage device(s), a supercapacitor charger, least one boost converter and at least one dump capacitor.

FIG. 15 is a circuit of a supercapacitor charger according to the present invention connected to a DC power input.

FIG. 16 is a circuit of a supercapacitor charger of FIG. 14, according to the present invention connected to a DC power input and a regeneration input.

### DETAILED DESCRIPTION OF THE PREFERRED EMBODIMENTS

The present invention will now be described with reference to the accompanying drawings, wherein the same reference numerals have been used to identify the same or similar elements throughout the several views.

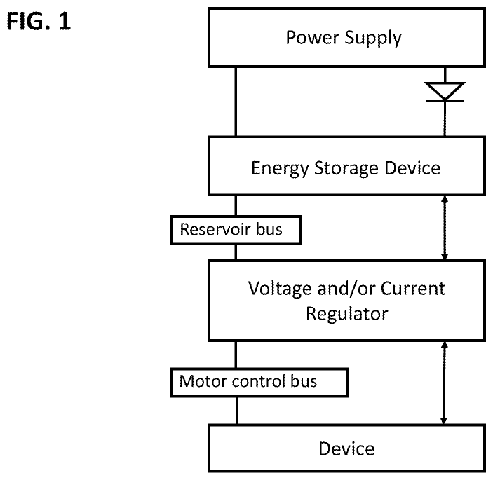

FIG. 1 is an illustration of the circuit of the present invention. In FIG. 1, the system includes a charger/power supply, as known in the art connected to an AC power source via a plug, at least one energy storage device, such as a supercapacitor or supercapacitor bank (e.g., a plurality of supercapacitor connected to one another), a boost circuit (e.g., boost converter) and optionally a buck circuit (e.g., buck converter). The system can be connected to a device, such as an EM device. Further each of the power supply, the at least one energy storage device, the boost circuit, the buck circuit and the EM device can be in a series connection to at least one EM device, and at least one motor controller of each EM device. When a plurality of energy storage devices are used, it can be referred to as an energy storage bank.

As shown in FIG. 1, a system includes a at least one energy storage device provided between the power supply and the boost circuit and optional buck circuit, and the boost circuit and the optional buck circuit provided between the at least one energy storage device and the EM device via a motor controller bus.

The boost circuit and optional buck circuit can be connected to the at least one energy storage device via a reservoir bus. Further a diode can be located between the at least one energy storage device and the power supply to allow current to flow from the power supply to the at least one energy storage device.

The buck circuit, also known as a buck converter or step-down converter is a DC-to-DC power converter which steps down voltage from a supply (input) to a load (output). It is a class of switched-mode power supply (SMPS) that can contain multiple semiconductors, such as a diode and a transistor, or multiple transistors, and at least one energy storage element, such as a capacitor, inductor or a combination of a capacitor(s) and inductor(s).

The present invention can utilize the buck circuit to provide energy from the EM device to the at least one energy storage device. That is, if excess energy is produced by the EM device, such as by an exertion of force applied by a user to the device (e.g., an exercise device) and the voltage exceeds a predetermined threshold value, the buck circuit can dump or otherwise transfer this excess energy back to at least one energy storage device.

The present invention can utilize multiple energy storage devices to capture regenerative energy from the EM device (i.e., the motor of the EM device), to avoid the need for a buck circuit altogether.

The boost circuit, also known as a boost converter, is a DC-to-DC power converter that steps up voltage from its supply (input) to its load (output). Like the buck circuit, the boost circuit is a class of SMPS containing at least two semiconductors (a diode and a transistor) and at least one energy storage element: a capacitor, inductor, or the two in combination. To reduce voltage ripple, filters comprising capacitors or a combination of capacitor and inductors are included in the converter's output (i.e., load-side filter) and input (i.e., supply-side filter).

The boost circuit in the present invention and the series connection between the power supply, the energy storage and a motor controller of the device, allows for a forward synchronous power delivery and for providing peak power delivery substantially in excess of power received via the power supply (i.e., from a utility service).

The power supply charges at least one energy storage device to a predetermined threshold, such as a predetermined charge, by providing limited power when the charge is below the threshold and not providing power when the charge is above the threshold. The power supply provided can be as known in the art, and can be an AC power supply, and DC power supply, or any type of power supply. The power supply can convert mains AC to regulated DC power (e.g., low voltage regulated DC power) for the internal component of the device.

The system of the present invention extracts power from the at least one energy storage via the reservoir bus when in a motoring mode of operation (e.g., when the device is operating and requires an energy input) and directs power to the at least one energy storage through the motor control bus and the reservoir bus when regenerating (e.g., when the device is producing an output of power greater than a predetermined threshold).

The embodiment of FIG. 1 has a reservoir bus that absorbs or provides energy, and a motor control bus connected to the EM device. The buck circuit and boost circuit routes energy between the reservoir bus and the motor control bus. Further, the buck circuit and the boost circuit can be provided in plurality.

Due to the capacitance of the energy storage, large quantities of power (e.g., well in excess of utility power, for example greater than four (4) times the power available from a utility service) can be extracted while only depressing (or conversely—absorbed while only increasing) the voltage of the energy a small/minimal amount, such as a 25% drop in voltage. That is, a system output to provides a voltage ripple below a voltage drop so as to not impact the output torque of the motor, thus allowing the motor to output a constant torque.

The motor control bus voltage is held steady to (1) encompass (i.e., stay above) any motor back-electromagnetic field (EMF) situation, (2) provide minimum torque ripple of the system (i.e., EM system) and (3) to not exceed voltage limits of the electrical components of the device. A +/−1% regulation of voltage is achieved by the system of the present invention. A back-emf is where the motor of the device acts like a generator and the emf against the applied voltage that is causing the motor to spin in the first place, and reduces the current flowing through the coils of the motor.

The present application has the advantages of a reduced bus voltage variation, as compared to the prior art. Specifically, when electrically connecting only a power supply a motor, a +/−2 to 3 volts variation in the bus voltage was produced. Using energy storage alone, which is the case for the present invention, only produced a +/−1 volt bus voltage. Further, it is known that when the energy storage and the AC power supply are arranged in parallel, such as the case in Gilstrom et al. discussed above, there should be a variation in the bus voltage similar to that when electrically connecting only a power supply a motor. That is, when the energy storage and the AC power supply are arranged in parallel, variation in the bus voltage is expected to be +/−2 to 3 volts.

In a system with bi-directional energy flow, and energy sources connected to both the input and output sides of an energy reservoir (such as but not exclusive to a motor-based resistance solution with a power supply, and motor, as described by the present invention invention), a series topology with regulation and/or isolation between the power supply and energy reservoir produces and/or the motor and energy reservoir produces a more stable bus voltage, which is important for control stability and smoothness of feel for the output of the system.

A regulator can be any of, but not limited to, the following: passive, active, hybrid passive-active, energy storage devices capable of storing and/or transferring energy such as: capacitors, boost converters, buck converters, or linear regulators

Another implementation is that when the energy storage device(s) includes a supercapacitor plus at least one battery (e.g., a plurality of batteries), the system/circuits of the present invention allows for an exercise device, or other electro-mechanical device, to be used even with the plug disconnected from the wall AC power.

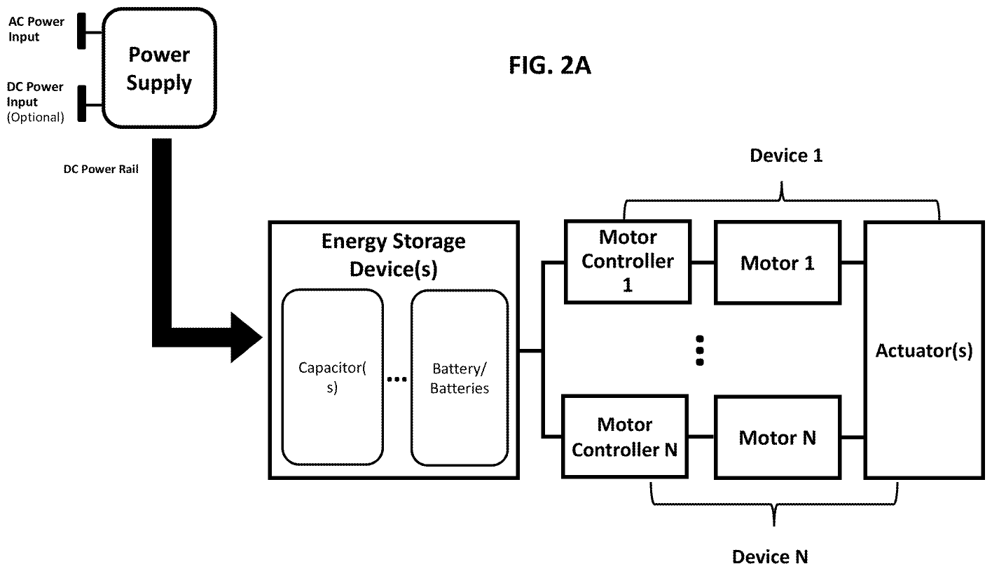

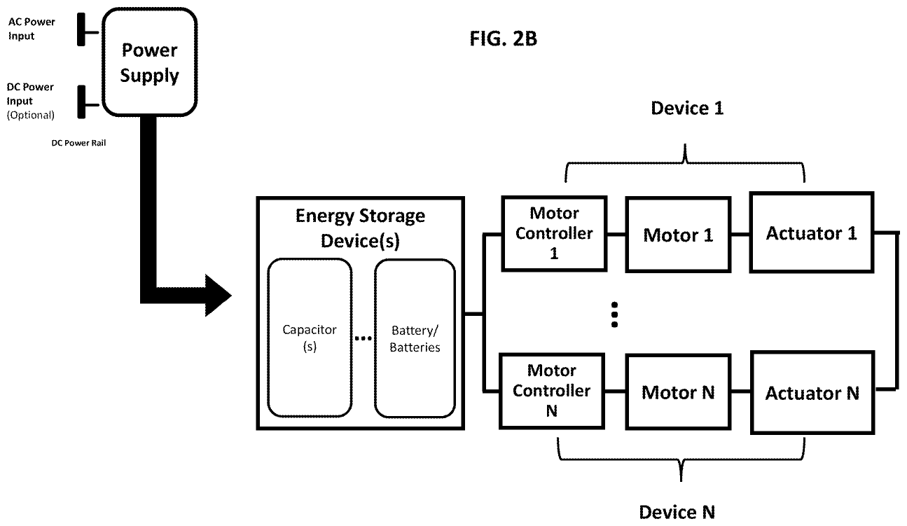

FIGS. 2A and 2B are illustrations of systems according to an embodiment of the present invention including a power supply, energy storage device(s) and without an energy storage regulator and without regenerative charging. FIGS. 2A and 2B provide the simplest form of adding storage capacity to a system that draws AC power or DC power to a motor controller of a device (e.g., machine, exercise machine, etc.), then on to a motor of the device, and then potentially eventually actuator of the device. One or “N” (as shown in the figures) number of motor controllers and motors can be used in the circuit/system of the present invention. The actuators of the machine/device (or plurality of machines/devices) can be arranged (e.g., connected to each other) in parallel. Further, the actuator can be any component of machine/device that produces motion, such as rotary motion or linear motion.

In conventional U.S. households, wall AC power can provide a maximum of 1500 Watts of power, however, for brief periods, humans, and in particular professional athletes, can be capable of requiring well in excess of 1500 watts of power. (There exist well documented and recorded events of up to 4800 Watts).

The “Device(s),” including Device 1 . . . Device N, can include an actuator (e.g., Actuator 1 . . . Actuator N), a motor (e.g., Motor 1 . . . Motor N), and a motor controller (e.g., Motor Controller 1 . . . Motor Controller N).

The power supply can be any type of AC/DC power conversion unit (PCU) and/or DC/DC PCU (e.g., the power supply can be provided in plurality or be a singular unit), as known in the art, for charging and powering the energy storage device(s), motor controller(s) and motor(s). That is, the power supply can convert electric current from a source power, including an AC power input, a DC power input, or a combination of an AC power input and a DC power input, to the correct voltage, current, and frequency to power the load (e.g., the energy storage device(s) and/or the motor controller and/or the motor and/or the actuator). The energy storage device(s) can be a one or more batteries (e.g., a bank of batteries), including any type of battery as mentioned above, and can be any combination of one or more capacitors, one or more supercapacitors, one or more inductive coils, and/or one or more hybrid supercapacitors. Types of batteries that can be used in the present invention include any combination of secondary batteries (e.g., rechargeable batteries) known in the art lithium batteries, including but not limited to lithium-ion, lithium-ion polymer (LiPo), nickel metal hydride (NiMH), lead-acid, nickel-cadmium (NiCd), nickel-zinc (NiZn), alkaline, etc.

The energy storage devices, when provided in plurality, can be arranged in parallel (e.g., in a parallel power sharing scheme). Alternatively, a plurality of energy storage devices can be arranged in series in the system of the present invention. Supercapacitors can be used in conjunction with one or more batteries to overcome some of the weaknesses of those electrochemical-based energy-storage components, such as reduced charge cycles and energy density.

In the figures, the “Capacitor(s)” as the energy storage device(s) can be replaced with supercapacitor(s) and “Supercapacitor(s) can likewise be replaced with any type of capacitors. A supercapacitor (SC), also called an ultracapacitor, a double-layer electrolytic capacitor, or “electrical double layer capacitor (EDLC),” is a high-capacity capacitor with an increased capacitance value, lower voltage limits and 10 to 100 times more energy per unit mass or volume compared to electrolytic capacitors (i.e., ordinary capacitors). Unlike ordinary capacitors, supercapacitors do not use the conventional solid dielectric, but rather, they use electrostatic double-layer capacitance and electrochemical pseudocapacitance, both of which contribute to the total capacitance of the capacitor. A supercapacitor has a larger plate area and a smaller distance between these plates, which are metallic and are soaked in electrolytes and are separated by a very thin insulator. An electric double layer is created in the supercapacitor as opposite charges are formed on both sides of the separator when the plates are charged. This results in a supercapacitor with greater capacitance. In contrast to a battery, the terminal voltage of a supercapacitor drops linearly as a function of the energy delivered.

Hybrid supercapacitors are asymmetric devices comprising a Li-doped graphite anode and an activated carbon cathode. Although the charge movement is mainly done electrochemically, it is at a significantly lower depth compared to the Li-ion battery. They combine the underlying structures of both batteries and supercapacitors in one physical unit, which results in a very high cycle-life count (a minimum of 500,000 cycles is typical), very fast responsiveness to high discharge rates and higher specific capacitance in comparison to existing electric double layer capacitors (EDLCs) and pseudocapacitors.

The energy storage devices noted above can be provided with a battery management system (BMS) or a cell management system (CMS), as known in the art, which manages the charging and discharging of the energy storage device(s) to ensure the proper charge (e.g., not overcharged or undercharged, and is therefore within a designated charge range), such as a particular/predetermined state of charge (SOC) range, a particular/predetermined voltage range, and/or a particular/predetermined current range. The BMS or CMS can also prevent thermal runaway or other fault conditions that can result in degraded performance, cell destruction, or even fire.

An inductive coil is known in the art as an electrical device for producing an intermittent source of high voltage and includes of a central cylindrical core of soft iron on which two insulated coils are wound: an inner (e.g., primary coil), having relatively few turns of copper wire, and a surrounding secondary coil, having a large number of turns of thinner copper wire. The inductive coil can also include an interrupter for making and breaking the current in the primary coil automatically, in which the current magnetizes the iron core and produces a large magnetic field throughout the induction coil.

The motor controller of the device can be any type of motor controller known in the art, such as a physical hardware-embedded processor that regulates the operation of the motor (e.g., electric motor). The motor controller can be a DC motor controller, an AC motor controller, a servo motor controller and a stepper motor controller.

The actuator of the device can request a fixed torque or a variable torque from the motor controller, which is coupled to a respective motor (or a plurality of motors), the energy storage device(s) and the power supply, and the actuator can produce resistance when used in an exercise device. For instance, the device can be a cable machine, in which a metal cable is physically (e.g., directly connected) connected to the actuator, and the actuator provides resistance to the metal cable. The motor controller adjusts the resistance of the actuator, including based on a user input. The user input can be a knob, as known in the art, or a display device with a user interface, as known in the art.

The motor can be any type of motor, such as an AC motor (e.g., brushed or brushless AC motor), a DC motor (brushed or brushless DC motor), a direct drive motor, a linear motor, a servo motor, a stepper motor, or the like.

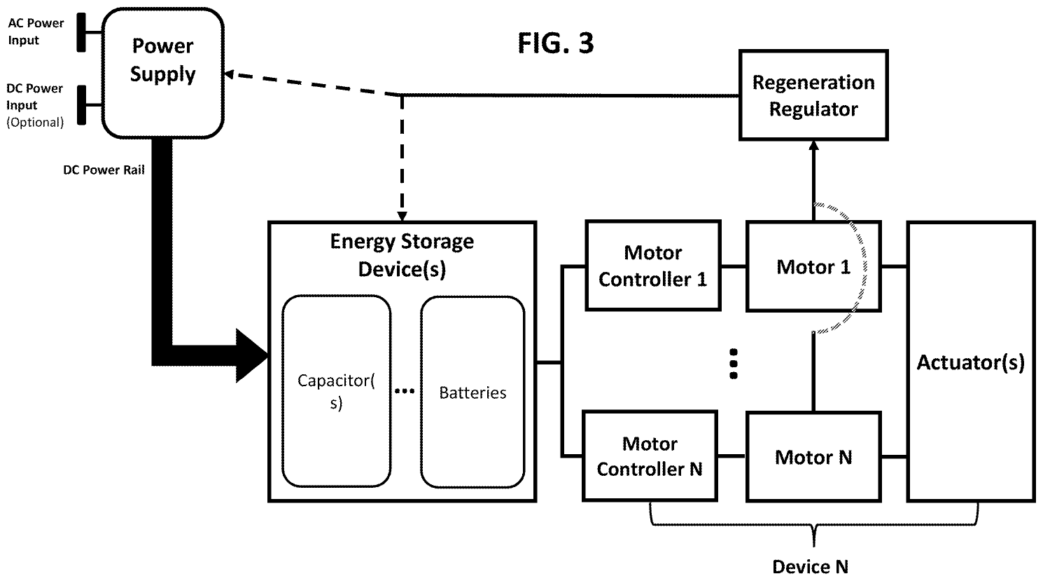

The system of FIGS. 2A and 2B is provided without regenerative charging (e.g., a regenerative circuit), and thus, excess energy produced by the actuators is unable to be received from the circuit (e.g., the energy storage device(s)). FIG. 2B is the same circuit as in FIG. 2A, with a plurality of actuators (Actuator “1” . . . Actuator “N”) connected in parallel (e.g., connected to each other in parallel). Further, the actuators of FIGS. 3-14 can be connected in parallel, as shown in FIG. 2B, but such a parallel arrangement is omitted for each of FIGS. 3-14, as one of ordinary skill in the art would readily recognize that the specific arrangement of the actuators of FIG. 2B can be provided in the systems of FIGS. 3-14.

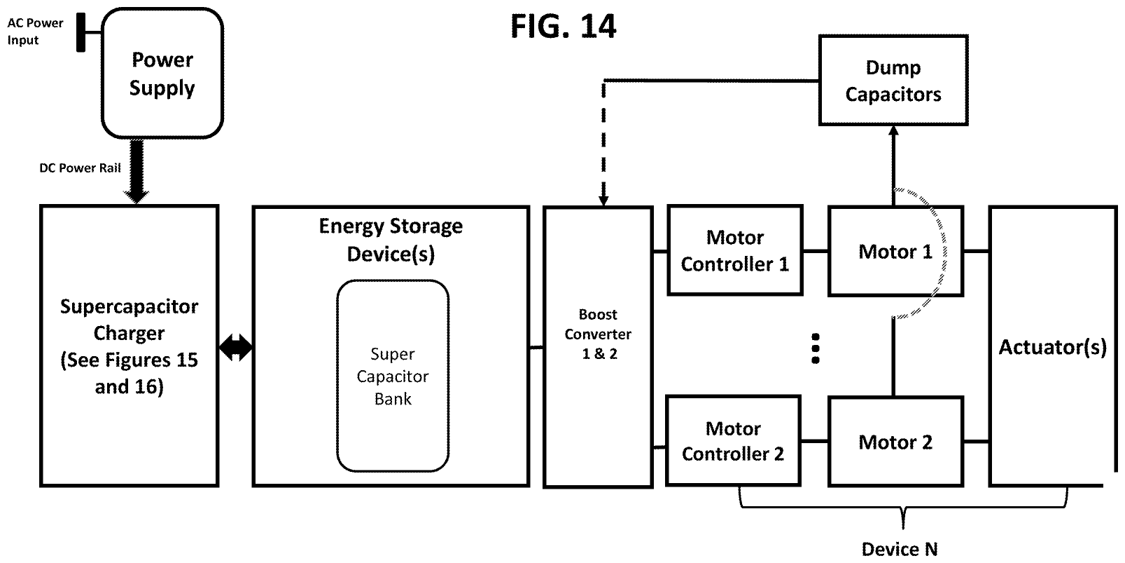

FIG. 3 is an illustration of a system according to an embodiment of the present invention including a power supply, energy storage device(s), regenerative charging and without an energy storage regulator. That is, the circuit of FIG. 3 is similar to that of FIGS. 2A and 2B, with the addition of a regeneration regulator (e.g., energy sink). The regeneration regulator can be provided in plurality. The regeneration regulator transfers power due to motor induction when work is done on the motor, for example, by a user applying excess force to the device, and this excess power transferred to energy storage device(s) and/or a regulator (e.g., energy storage regulator, motor regulator, etc.) and/or the power supply. The regeneration regulator can be a dump capacitor (e.g., dump circuit, as known in the art) (as shown in FIG. 14), a capacitor, a supercapacitor, a buck converter (described later) and/or an amplifier circuit that employs a positive feedback, with the output of the regeneration regulator being applied to the input (e.g., energy storage device(s) and/or power supply, or power supply and/or energy storage device(s). The regeneration regulator, including the dump capacitor(s), may filter noise in the regeneration energy from the motor(s), as know in the art.

The function of the regeneration regulator is to regulate the current or voltage of the power generated by the motor during regeneration before feeding that regeneration energy back into the system (i.e., the circuit). The regeneration energy can be placed back into the system in multiple ways, as will be seen in the additional figures.

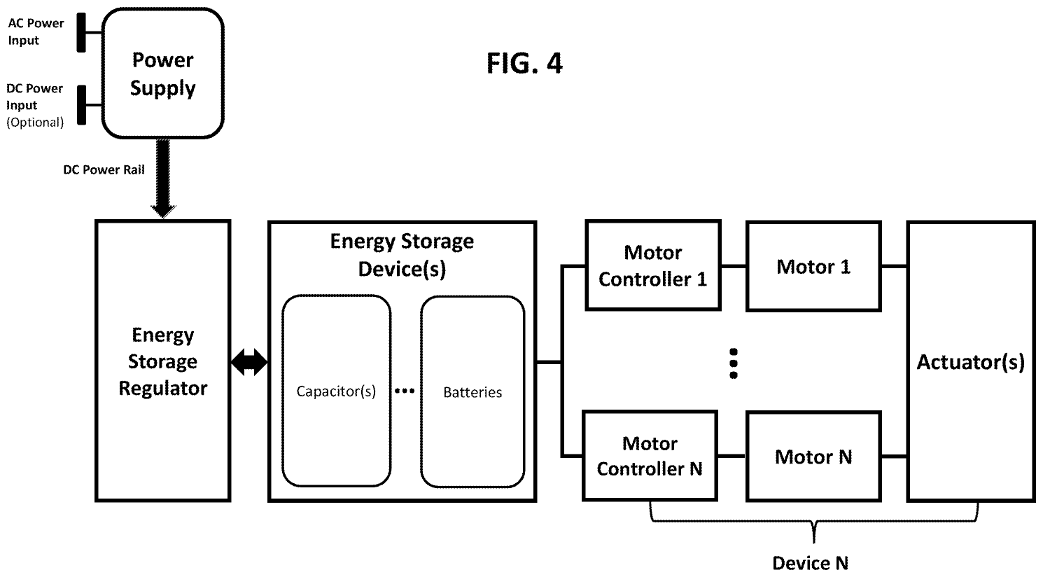

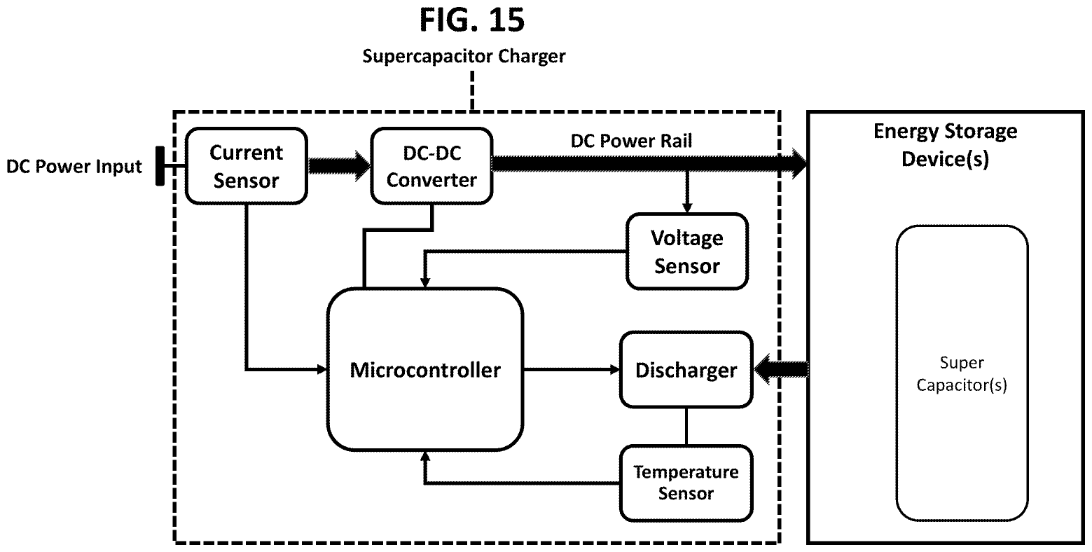

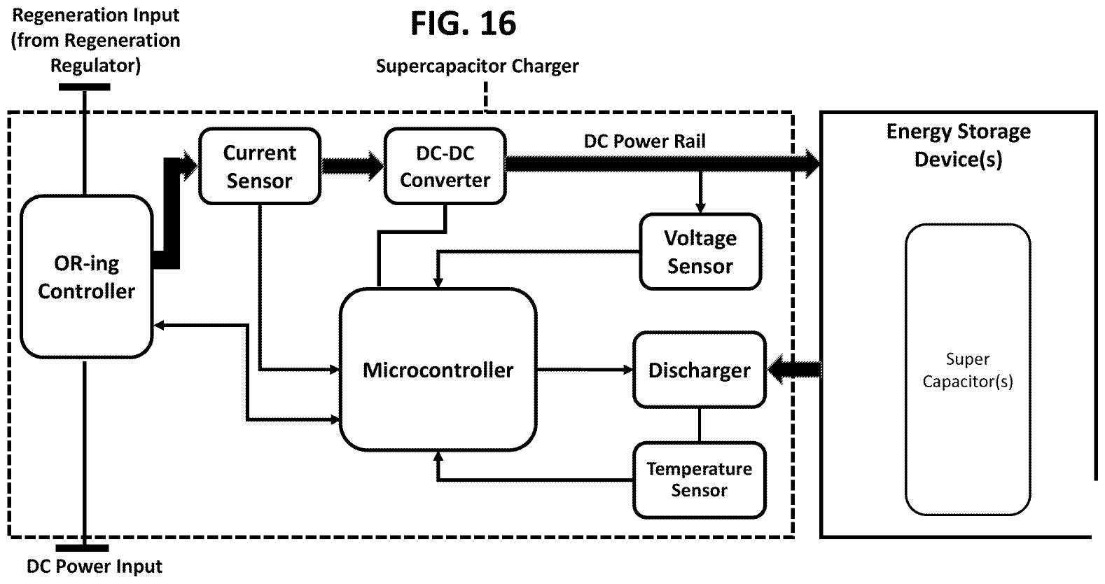

FIG. 4 is an illustration of a system according to an embodiment of the present invention including a power supply, energy storage device(s) and an energy storage regulator and without regenerative charging. That is, the circuit of FIG. 4 employs the component of FIGS. 2A and 2B, with the addition of an energy storage regulator between the power supply and the energy storage device(s). The energy storage regulator (ESR) can be a DC/DC voltage regulator, a current regulator (e.g., a linear regulator, a switched-mode power supply (SMPS), or a supercapacitor charger, as illustrated in FIG. 15 and FIG. 16.

A SMPS is an electronic power supply that incorporates a switching regulator to convert electrical power efficiently and transfers power from a DC or AC source to DC loads, such as a personal computer, while converting voltage and current characteristics within operable range of the energy storage device(s).

That is, the energy storage regulator regulates current, voltage or current and voltage from the power supply to supply a predetermined current, voltage or current and voltage to the energy storage device(s). Specifically, the energy storage regulator regulates the current and/voltage coming out of the power supply before going into the energy storage device(s).

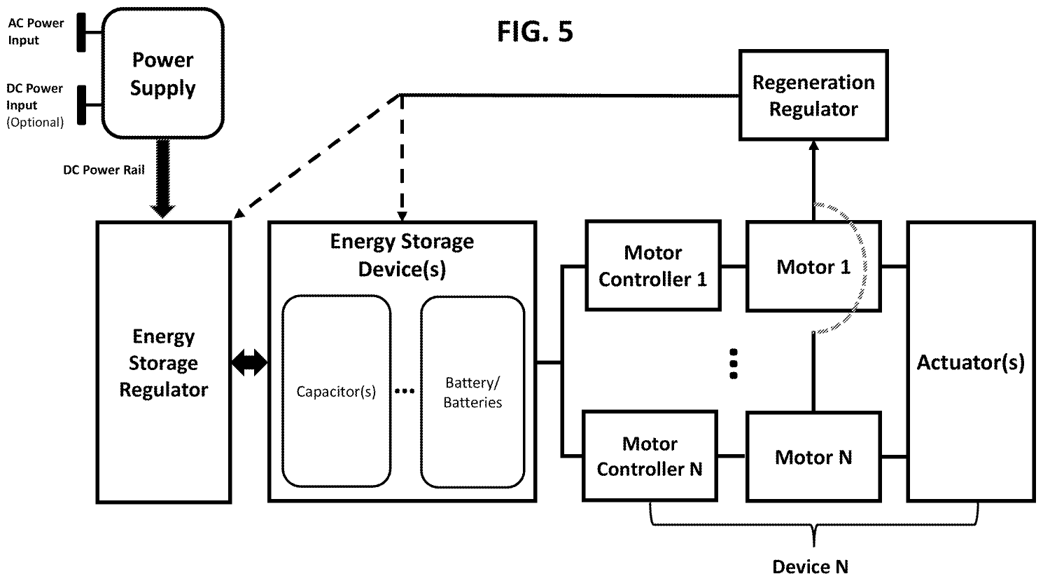

FIG. 5 is an illustration of a system according to an embodiment of the present invention including a power supply, energy storage device(s), an energy storage regulator and regenerative charging. That is, the circuit of FIG. 5 employs the circuit of FIG. 4 with the addition of regenerative charging (e.g., a regenerative regulator as discussed above). In this case, the regenerative regulator transfers energy to the energy storage device(s) and/or to the energy storage regulator.

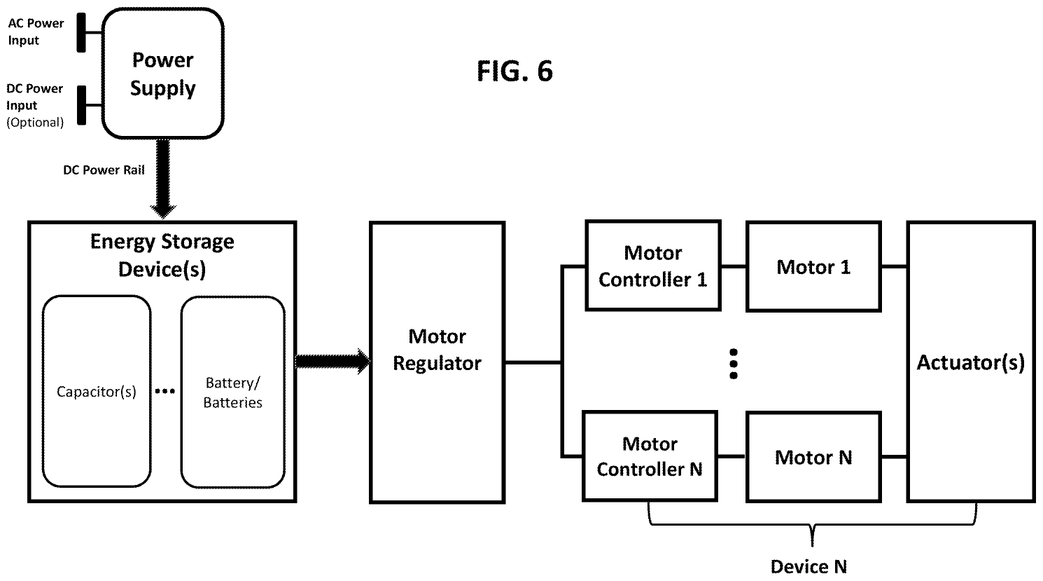

FIG. 6 is an illustration of a system according to an embodiment of the present invention including a power supply, energy storage device(s) and a motor regulator. That is, the circuit of FIG. 6 employs the circuit of FIGS. 2A and 2B with the addition of a motor regulator (e.g., logic controlled voltage regulator, boost circuit, etc.) between (e.g., directly between) the motor controller(s) and the energy storage device(s). The motor regulator can be directly electrically connected between the motor controller(s) and the energy storage device(s). The motor regulator can be a DC/DC voltage regulator, as known in the art, and operates to maintain a voltage of the motor controller(s) and a bus voltage of the motor. The motor regulator can include a boost converter, or a plurality of boost converters, a voltage regulator, such as a linear voltage regulator, series voltage regulators, shunt voltage regulators, switching voltage regulators, and switching topologies. Switching topologies include dielectric isolation and non-isolation. The motor regulator can also be a logic controlled voltage regulator. Dielectric isolation includes flyback converter(s) and/or forward converter(s). Non-isolation includes buck converter(s) (e.g., step-down voltage regulator(s)), boost converter(s) (step-up voltage regulator(s) or voltage inverters), or buck converter(s) and boost converter(s). Switching topologies are efficient and provide reduced weight and size as compared to non-switching topologies. Additionally, electronic voltage regulator(s), including transistor voltage regulator(s) can be employed in as the motor regulator according to all corresponding embodiments of the present invention. An electronic voltage regulator is as known in the art.

FIG. 6 adds the functionality of the motor regulator, e.g., a current regulator or voltage regulator, to regulate the current or voltage of the energy/power coming out of the energy storage device(s) before going into the motor controller of the device. One example can be that the energy storage device(s) operates at 48 Volts but higher voltage is needed for the motor, which might run at, for example, 70 Volts. That is, the circuit of FIG. 6 can increase the current coming out of the energy storage device(s), especially in the case in which the motor(s) of the device(s) operates at a higher current than is possible from wall power alone (e.g., typical U.S. household AC power).

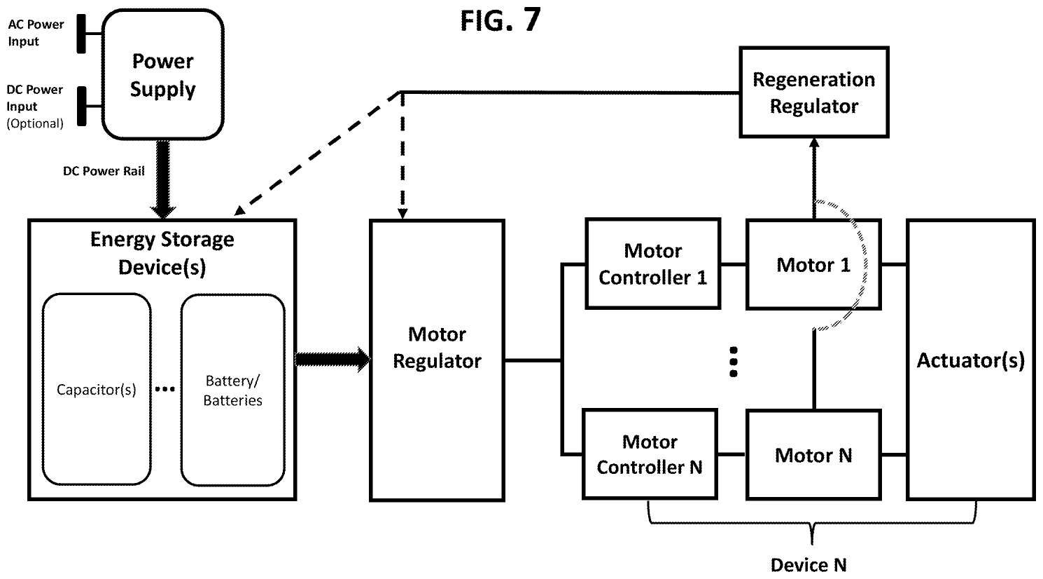

FIG. 7 is an illustration of a system according to an embodiment of the present invention including a power supply, energy storage device(s), a motor regulator and regenerative charging. FIG. 7 employs the circuit of FIG. 6, with the addition of a regeneration regulator, as described previously.

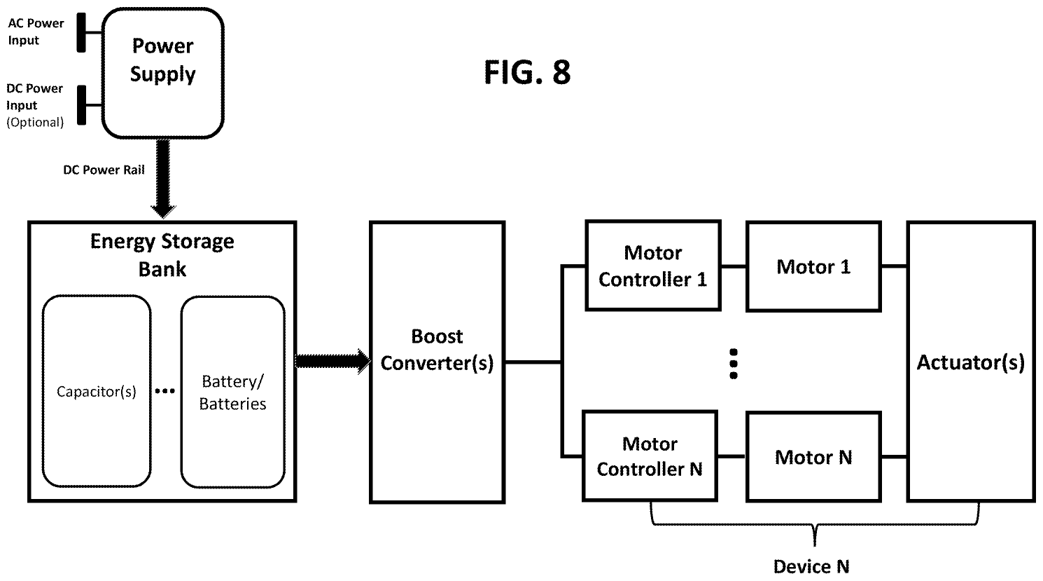

FIG. 8 is an illustration of a system according to an embodiment of the present invention including a power supply, energy storage device(s), at least one boost converter as the specific motor regulator, and without regenerative charging. FIG. 8 employs the circuit of FIGS. 2A and 2B with the addition of boost converter(s) as the motor regulator (e.g., the boost converter(s) are a specific type of motor regulator). The boost converter is as previously described and as known in the art. The boost converter(s) boost the voltage coming out of the energy storage device(s) before going into the motor controller(s) of the device.

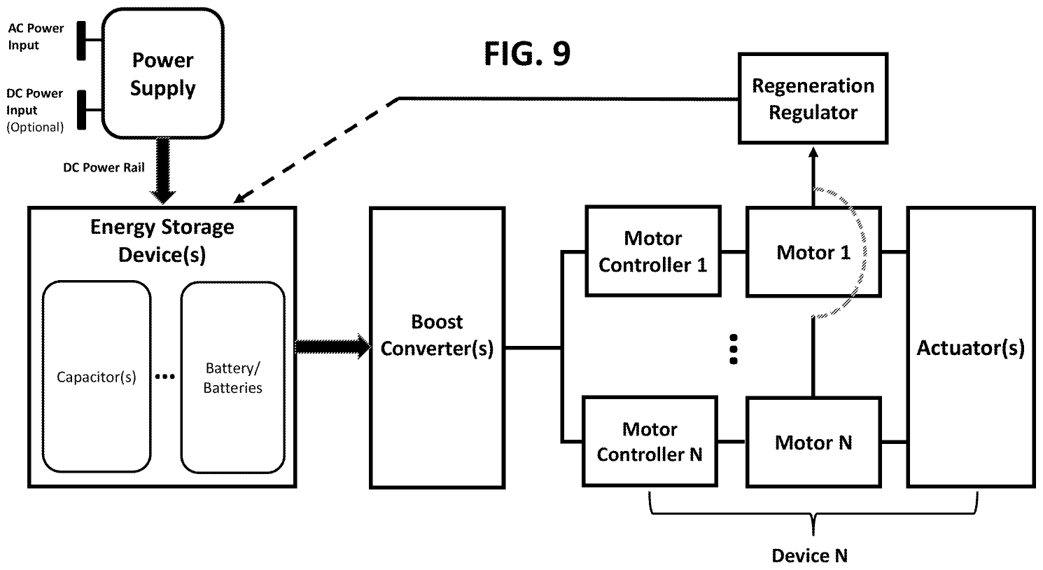

FIG. 9 is an illustration of a system according to an embodiment of the present invention including a power supply, energy storage device(s), boost converter(s) and regenerative charging. That is, the circuit of FIG. 9 employs the circuit of FIG. 8 with the addition of a regeneration regulator, as previously described.

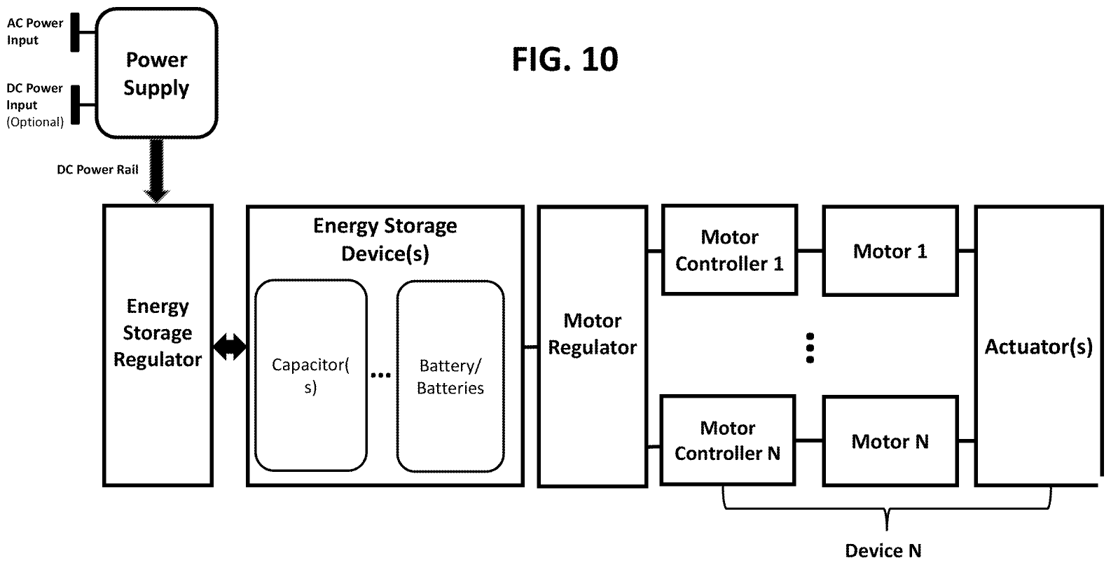

FIG. 10 is an illustration of a system according to an embodiment of the present invention including a power supply, energy storage device(s), an energy storage regulator, a motor regulator and without regenerative charging. Each of the energy storage regulator and the motor regulator can be provided in plurality. The plurality of energy storage regulators can be arranged in series or in parallel and the plurality of motor regulators can be arranged in series or in parallel.

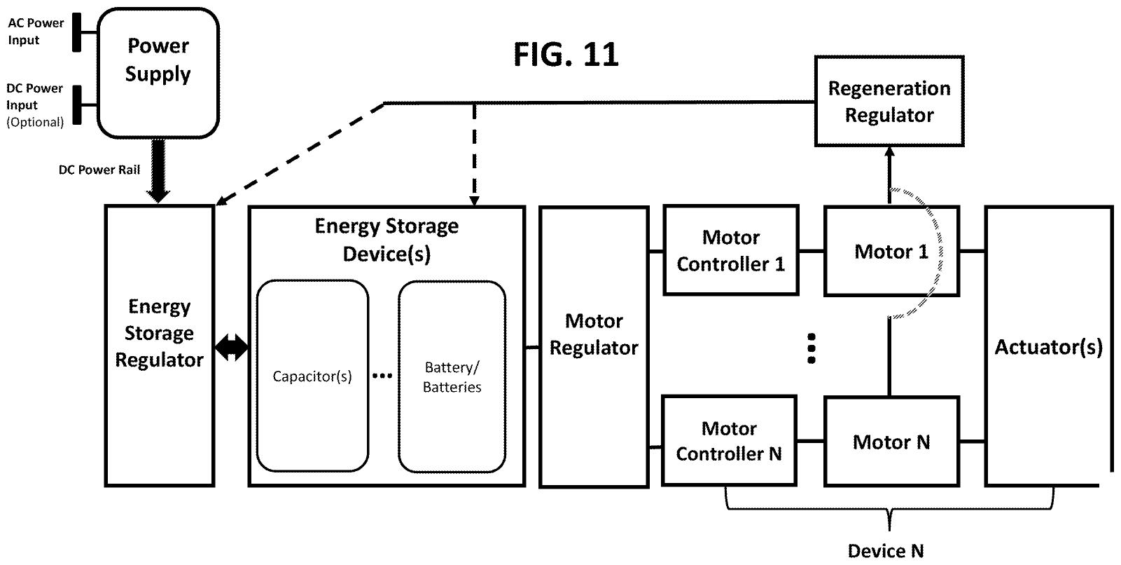

FIG. 11 is an illustration of a system according to an embodiment of the present invention including a power supply, energy storage device(s), an energy storage regulator, a motor regulator and regenerative charging. That is, the circuit of FIG. 11 employs the circuit of FIG. 10, with the addition of a regeneration regulator, as discussed above.

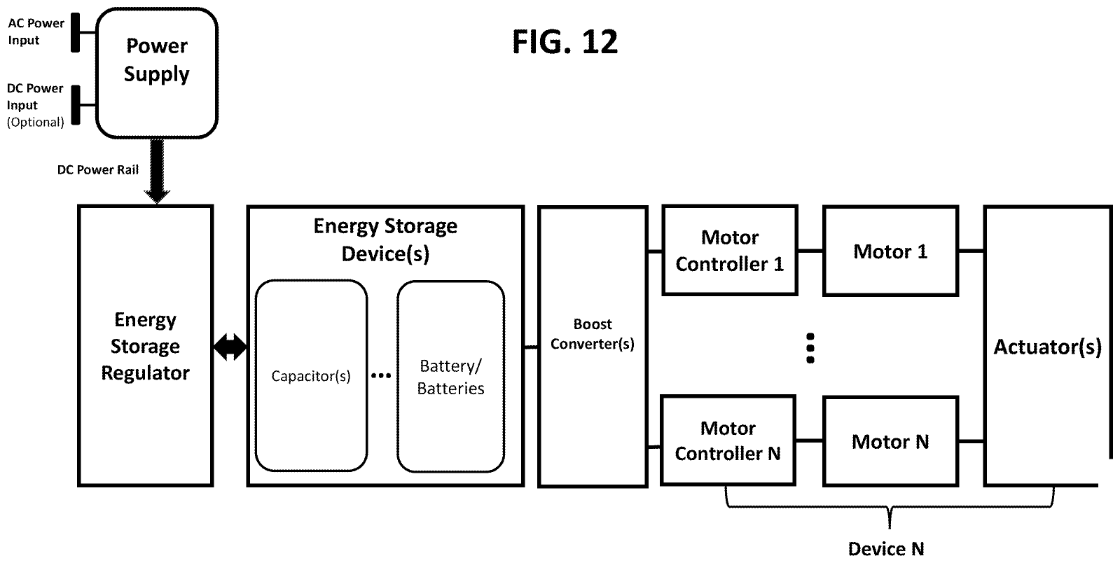

FIG. 12 is an illustration of a system according to an embodiment of the present invention including a power supply, energy storage device(s), an energy storage regulator, at least one boost converter and without regenerative charging. That is, FIG. 12 employs the circuit of FIG. 10, in which the motor regulator is specified as at least one boost converter.

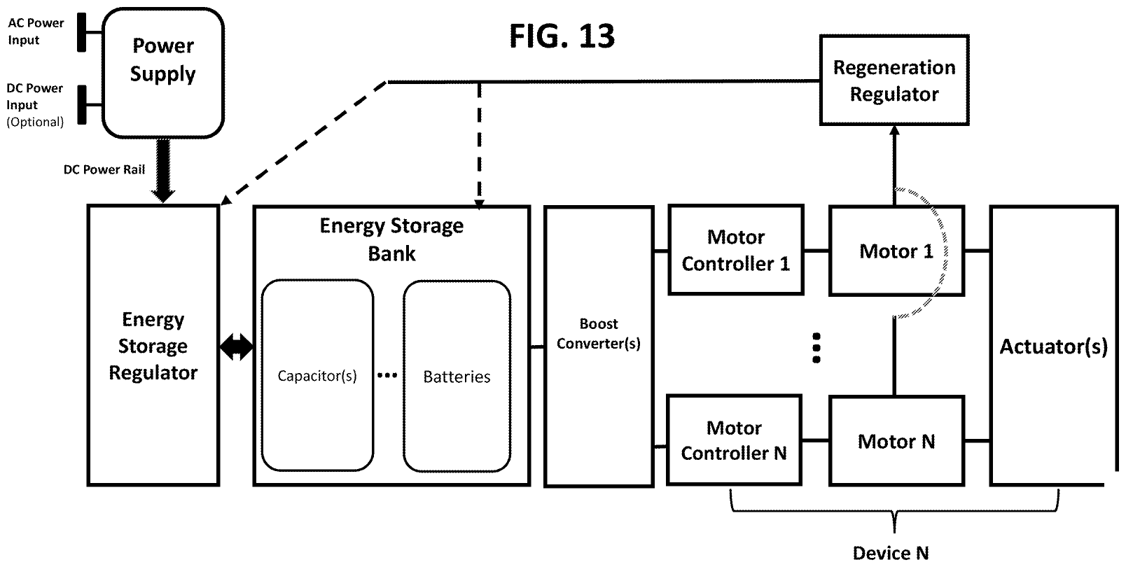

FIG. 13 is an illustration of a system according to an embodiment of the present invention including a power supply, energy storage device(s), an energy storage regulator, at least one boost converter and regenerative charging. That is, the circuit of FIG. 13 employs the circuit of FIG. 11, in which the motor regulator is at least one boost converter.

FIG. 14 is an illustration of a system according to an embodiment of the present invention including a power supply, a supercapacitor bank as the energy storage devices, a supercapacitor charger, at least one boost converter, and at least one dump capacitor. The at least one dump capacitor is connected to the one or more motors of the device(s), and discharges energy to the at least one boost converter. The supercapacitor charger is as shown in FIG. 15 or FIG. 16 and described later.

FIG. 15 is a circuit of a supercapacitor charger according to the present invention connected to a DC power input (e.g., from the power supply, which is connected to AC power, as described above and known in the art). The supercapacitor charger includes a microcontroller, a current sensor, a DC-DC converter, a DC power rail, a voltage sensor, a discharger (e.g., buck converter, dump capacitor, etc.) and a temperature sensor provided on a supercharger circuit board. The microcontroller can be a hardware-embedded processor implemented in a computer-readable medium using, for example, software, hardware, or some combination thereof, as described later. The supercapacitor charger can control (e.g., is configured to control) the charging and discharging of the one or more supercapacitors (e.g., supercapacitor bank) connected thereto. The supercapacitor charger of FIG. 15 can replace the energy storage regulator in FIGS. 4, 5 and 10-14.

The supercharger circuit board, in the feedforward path, has a current sensor, voltage sensor, and a discharger (e.g., buck converter) that is capable of operating at full 100% duty-cycle (e.g., latches a PMOS transistor full on). The microcontroller collates this data to control the charge of the supercapacitor(s) from an arbitrary power source on the input (DC power input). The supercapacitor charger of FIG. 15 allows a general power source to charge a large supercapacitor (e.g., a supercapacitor with large storage, enough to support the demands of the device, including at least 1500 Watts) or a plurality/bank of supercapacitors without putting the input power source into an overvoltage, an overcurrent, or an over-temperature condition by continuously varying current and voltage on input to the energy storage devices (e.g., energy storage bank or super capacitor(s)) to achieve a full energy storage in the bank for dynamic power conditions due to motor operation.

PMOS uses p-channel (+) metal-oxide-semiconductor field effect transistors (MOSFETs) to implement logic gates and other digital circuits and PMOS transistors operate by creating an inversion layer in an n-type transistor body. This inversion layer, called the p-channel, can conduct holes between p-type “source” and “drain” terminals.

In the feedback path, the first step (e.g., step 1) is to isolate from wall power, the second step (e.g., step 2) is to monitor the voltage and current of the supercapacitor(s), and the third step (e.g., step 3) is to turn driver circuitry on/off to discharge energy storage device(s) at controllable rates in order to assure safety, device life, energy storage performance and proper operation of the energy storage.

In the supercapacitor charger of FIG. 15, the microcontroller can be directly connected (e.g., directly electrically connected) to the current sensor, the DC-DC converter, the voltage sensor, the discharger and the temperature sensor. The one-way arrows in FIG. 15 into the microcontroller can represents a one-way communication between the respective device and the microcontroller.

The microcontroller takes inputs from the current sensor, voltage sensor, DC-DC converter and temperature sensor and modulates the power transferred from the DC power input through the DC power rail to the energy storage device(s), to ensure the supercapacitor(s) operate within predetermine a voltage and/or current range.

The current sensor can be as known in the art, including a hall effect sensor, an inductive sensor and/or a magnetoresistive sensor, but is not limited thereto. The voltage sensor can be as known in the art, including a capacitive voltage sensor and/or a resistive voltage sensor, but is not limited thereto. The temperature sensor can be as known in the art, including a negative temperature coefficient (NTC) thermistor, resistance temperature detector (RTD), a thermocouple, and/or semiconductor-based sensors, but is not limited thereto. The current sensor can be provided in plurality, the voltage sensor can be provided in plurality, and the temperature sensor can be provided in plurality.

FIG. 16 is an alternate circuit of a supercapacitor charger of FIG. 14, according to the present invention, which is connected to both a DC power input and a regeneration input (e.g., from a regeneration regulator, such as illustrated in FIGS. 3, 5, 7, 9, 11, 13 and 14. That is, the supercapacitor charge of FIG. 16 employs the same components as the supercapacitor charger of FIG. 15, with the addition of a regeneration input (e.g., from a regeneration regulator), such as shown in the figures and an OR-in controller. The supercapacitor charger of FIG. 16 enables the energy storage device(s) (e.g., supercapacitor(s)) to be charged by DC power input (e.g., coming from the power supply) and the regeneration energy (as described above with respect to the regeneration regulator) simultaneously.

The OR-ing controller is connected to the regeneration regulator and to the power supply and enables (e.g., is configured to enable) DC power from the power supply and power from the regeneration regulator to charge the energy storage device(s) (e.g., supercapacitor(s)) simultaneously. The OR-ing controller can also be connected to the microcontroller and to a current sensor. The OR-ing controller, also known as an “ORing” diode controller or ideal diode controller, is a device that creates near perfect diodes using signal or back-to-back N-channel or P-channel MOSFETs. They are used in applications that require a low loss OR connection of multiple power supplies, in the present case in the DC power input and the regeneration input represent the multiple power sources. The OR-ing controller minimizes the losses associated with these connections (e.g., the connection to the DC power input and the regeneration input). This improves the efficiency of the system, lowers the power dissipated as heat and reduces the voltage drop across the supercapacitor charger circuit.

The components/devices of FIGS. 1-16 can be directly connected, such as directly electrically connected with no components therebetween. For instance, in FIGS. 2A and 2B, the power supply can be directly connected to the energy storage device(s), the energy storage device(s) can be directly connected to the motor controller(s), the motor controller(s) can be directly connected to the respective motors, and the motor(s) can be directly connected to the actuator(s).

Further, FIGS. 3-14 illustrate a single actuator, however, if a plurality of actuators are used, then they can be arranged in parallel, as shown in FIG. 2B. Further, for all of the embodiments of the present application, one actuator can be connected to a plurality of motors and motor controllers, in series, as shown in FIG. 2A. That is, a single device can include only one actuator but also include a plurality of motors, and each of the plurality of motors can include a respective motor controller. Further, a single device can include a plurality of actuators, a plurality of motors and a plurality of motor controllers.

The system of the present invention (e.g., circuits of FIGS. 1-16) provides both greater output torque and speed from a given motor than otherwise possible without the present invention. Meaning, by only using wall power or an energy storage device, the motor torque can increase by increasing current or voltage to the motor(s) of the device(s), or motor speed can increase by increasing current or voltage to the motor(s) of the device(s), however, both torque and speed cannot increase. However, the present invention allows for an increase in speed and torque of the motor(s) of the device(s). This effect is due to an increase in power available to the motor(s) as compared to solely a wall power source (e.g., conventional AC power source). The present invention also provides the benefit of increased amperage than possible from a wall outlet (e.g., 25 amp circuit), in order to provide increase resistance to an actuator or actuators of a device.

Further, the present invention provides greater control and precision of the motor(s) than otherwise possible without our invention. As compared to a system can be able to provide a resistance of 50 pounds to a user, within a tolerance of +/−15 pounds, the present invention can provide 50 pounds of resistance within a tolerance of +/−5 pounds, for example. However, the present invention is not limited to this tolerance range, and a smaller tolerance range can be achieved by the system of the present invention, as illustrated in FIGS. 1-16.

Further, the present invention provide clean power (e.g., low noise in the signal), which is achieved by the power supply, the energy storage device(s) (e.g., super capacitor bank), which acts as a filter, one or more dump capacitors which filter noise in the regeneration energy, and any other capacitors present within the system that are on the various chip boards as described above.

The present invention also provides the advantage of stable power (e.g., bus voltage to the motor(s) is sufficiently stable such that variations in voltage are not transferred to the motor and control algorithms). This benefit of stable power is achieved by the energy storage device(s), which provide more stable power than wall power, and also further achieved by the motor regulator, which further regulates energy coming out of the energy storage device(s).

The present invention also provides the advantage of higher current than what is available from wall power. The higher current is achieved by using energy storage device(s) that can provide higher current than the wall power. Higher current to the motor(s) is needed to provide higher resistance levels to the user.

The present invention also provides the advantage of higher voltage than what is available directly from the energy storage device(s). This is necessary to provide the required resistance levels to the user. For example, in order to be able to spin the motor(s) at the required speed and torque, the voltage will need to be boosted. This boost in voltage is achieved by using a motor regulators, such as a boost converter (or a plurality of boost converters), which boosts the voltage coming out of the energy storage device(s) before sending it to the motor controller(s).

The supercapacitor chargers of FIGS. 15 and 16, allow a general power source to charge a large supercapacitor without putting the input power source (AC power input from wall power) into an overvoltage or overcurrent condition by continuously varying current and voltage on input to the energy storage device(s) (e.g., super capacitor(s)) to achieve a full energy storage in the energy storage for dynamic power conditions due to motor operation.

The various devices shown in FIGS. 1-16 can be provided in plurality and the plurality of devices can be connected to each other in series or in parallel (i.e., a series connection or a parallel connection). For each, the motor regulator can include a plurality of motor regulators, and the plurality of motor regulators can be in series or in parallel. Similarly, the energy storage regulator can include a plurality of energy storage regulators, and the plurality of energy storage regulators can be arranged in series or in parallel. Similarly, the energy storage device can include a plurality of energy storage devices, and the plurality of energy storage devices can be arranged in series or in parallel. Similarly, the regeneration regulator can include a plurality of regeneration regulators, and the plurality of regeneration regulators can be arranged in series or in parallel.

The systems of FIGS. 1-16 can used for more than one device (e.g., more than one exercise machine. Two devices (e.g., machine/exercise machines) can be positioned adjacent/near one another, with each machine having the necessary mechanical and structural components needed for it to be a complete exercise machine, however, only one machine can contain the electro-mechanical & computer-based equipment (e.g., the energy storage, the motor(s), boost converter(s), logic controller(s), force sensor(s), etc.) needed to power both machines either individually or simultaneously.

In each of the embodiments of FIGS. 1-16, the systems can include the device(s), including the motor(s) of the device, the motor controller(s) of the device(s), and the actuator(s) of the device(s). Examples of devices the system of FIGS. 1-16 can be used include industrial and/or commercial AC/DC converters, high power DC/DC converters, solar generators, or other such devices and/or systems (e.g., any arbitrary power source).

The regeneration regulator of FIGS. 3, 5, 7, 9, 11 and 13 can be provided in plurality, and can be (e.g., can be replaced with) a dump capacitor (e.g., dump circuit, as known in the art), a capacitor, a supercapacitor, a buck converter (described later) and/or an amplifier circuit. The motor regulator of FIGS. 6, 7, 10, 11 can be provided in plurality and can be (e.g., can be replaced with) a boost converter, or a plurality of boost converters, a voltage regulator, such as a linear voltage regulator, series voltage regulators, shunt voltage regulators, switching voltage regulators, and switching topologies. The energy storage regulator of FIGS. 4, 5 and 10-13 can be (e.g., can be replaced with) a DC/DC voltage regulator, a current regulator (e.g., a linear regulator, a switched-mode power supply (SMPS), or a supercapacitor charger.

Further “N” in FIGS. 2-14 represents any positive number above 1. Further, FIGS. 1-16 illustrate various components in one of a series connection or a parallel connection. For instance, FIGS. 2A and 2B illustrate a series connection between the power supply, the energy storage device(s) and the device(s). Similarly, FIG. 4 illustrates a series connection between the power supply, the energy storage regulator, the energy storage device(s) and the device(s). The motors and motor controllers are illustrated as having a parallel connection, however, they can alternatively be provided with a series connection.

The series connection between the power supply, the energy storage device(s) and the device(s) (e.g., including the motor controller(s), the motor(s) and the actuator(s)), is a critical feature of the present invention, as it permits only the energy storage device(s) to supply energy to the device(s), which in turn allows for improved voltage control and tolerance and improved feel to a user. For instance, since the present invention very finely (e.g., precisely) controls the voltage to the actuator(s) of the devices, a user can experience smooth and reliable resistance through an entire exercise motion, which is not achieved in known devices which receive power from wall power (and which may include a parallel connection between the energy storage devices and wall power).

One example of a power-drawing device (e.g., an electro-mechanical device) can be a motor of a motor-based resistance exercise machine. Other examples devices can include but are not limited to: a welding apparatus, robotics and motion control, CNC machinery, or any other power-drawing device. These all refer to unidirectional energy flow.

The actuator(s) can be any end-use object held by a user during an exercise sequence, including but not limited to a handle, grip, bar, bicycle pedal, treadmill track, rowing oar or bar, or other similar objects, but is not limited thereto.

Examples with bi-directional energy flow can include a motor of a motor-based exercise machine, where the motor generates energy when work is done to it (e.g., can supply energy back into the energy storage device(s) by a regeneration regulator, as described above). Other examples would be devices that can operate wherein they do work when energy is supplied to them, or they produce energy when work is done to them. Another example would be an energy harvesting system.

Various embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. For Example, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

The disclosure of which described above is not limited to the materials and features described therein, and can be changed within the scope of one ordinary skill in the art.

What is claimed is:

1. An electromechanical (EM) system, comprising:
an energy storage device configured to supply power to a device; and
a power supply configured to be connected to an alternating current (AC) power source and to supply energy to the energy storage device,
wherein only the energy storage device is configured to supply energy to the device,
wherein the energy storage device is capable of supplying energy to the device greater than energy supplied from the power supply alone, and
wherein the energy storage device is further capable of providing power to the device with less ripple voltage and less ripple current than power provided from the power supply.

2. The system of claim 1, further comprising the device, and
wherein the device is an electromechanical (EM) device, and
wherein the EM device generates energy when work is applied to the EM device.

3. The system of claim 2, further comprising a regeneration regulator connected to the EM device and configured to capture energy generated by the EM device and transfer the generated energy to the energy storage device when the work applied to the EM device exceeds a predetermined threshold.

4. The system of claim 3, further comprising a motor regulator configured to maintain a voltage of a motor controller of the device and a bus voltage of the motor to prevent an over/under voltage of the motor controller and to exceed motor back electromotive force (EMF),
wherein the regeneration regulator is connected between the motor and the motor regulator, and is configured to discharge energy from the motor to the motor regulator.

5. The system of claim 4, further comprising a supercapacitor charger between the power supply and the energy storage device, the supercapacitor charger including:
a current sensor;
a voltage sensor;
a microcontroller connected to the current sensor and to the voltage sensor; and
an OR-ing controller connected to the regeneration regulator and to the power supply and configured to enable DC power from the power supply and power from the regeneration regulator to charge the energy storage capacitor simultaneously.

6. The system of claim 5, wherein the regeneration regulator is a logic-controlled buck converter connected to the energy storage device and to a motor of the device, and
wherein the logic-controlled buck converter is configured to regulate and transfer regenerative energy from the motor to the energy storage device to recharge the energy storage device and so the regenerative energy does not cause a bus voltage of the device to exceed a maximum voltage acceptable to a motor controller of the device.

7. The system of claim 1, further comprising:
the device, wherein the device includes:
an actuator;
a motor; and
a motor controller configured to control the motor of the device; and
a boost converter connected between the motor controller and the energy storage device, wherein the boost converter is configured to increase an output of the energy storage device to increase power available to the motor.

8. The system of claim 7, further comprising a buck converter connected to the energy storage device and the motor of the device,
wherein the buck converter is configured to regulate and transfer regenerative energy from the motor to the energy storage device so the regenerative energy does not cause a bus voltage of the device to exceed a maximum voltage acceptable to the motor controller of the device.

9. The system of claim 1, further comprising:
the device, wherein the device includes:
a motor controller configured to control a motor of the device; and
a motor regulator connected between a motor of the device and the energy storage device,
wherein the motor regulator is configured to maintain a voltage of the motor controller of the device and a bus voltage of the motor to prevent an over/under voltage of the motor controller and to exceed motor back electromotive force (EMF).

10. The system of claim 9, further comprising an energy storage regulator between the power supply and the energy storage device, the energy storage regulator being a DC/DC voltage or current regulator configured to regulate power into the energy storage device.

11. The system of claim 10, wherein the energy storage device is a first energy storage device among a plurality of energy storage devices of the system, and
wherein the plurality of energy storage devices are connected in series.

12. An electromechanical (EM) system, comprising:
a plurality of energy storage devices, the plurality of energy storage devices being connected to each other in series;
a power supply configured to be connected to an alternating current (AC) power source and to supply energy to the plurality of energy storage devices; and
a motor regulator configured to increase an output of the plurality of energy storage devices to increase power available to motors of a plurality of electromechanical (EM) devices arranged in parallel such that the boosted output of the plurality of energy storage devices supports desired torque-speed requirements of the plurality of EM devices,
wherein a first bus voltage on a first side of the plurality of energy storage devices is different than a second bus voltage on a second side of the plurality of energy storage devices, and
wherein only the plurality of energy storage devices is configured to supply energy to the plurality of EM devices.

13. The system of claim 13, further comprising a regeneration regulator on an output of the plurality of EM devices to capture regenerative energy and to transfer the regenerative energy into the plurality of energy storage devices so that the second bus voltage does not exceed a predetermined maximum amount.

14. The system of claim 13, further comprising an energy storage regulator connected between the power supply and the plurality of energy storage devices, the energy storage regulator being a DC/DC voltage or current regulator configured to regulate power into the plurality of energy storage devices.

15. The system of claim 14, further comprising the plurality of devices,
each of the plurality of devices includes:
an actuator;
a motor; and
a motor controller configured to control the motor of the device; and
wherein the motor regulator is a boost converter.

16. An electromechanical (EM) system, comprising:
an energy storage device configured to supply power to a device;
a power supply configured to be connected to an alternating current (AC) power source and to supply energy to the energy storage device;
an energy storage regulator connected between the energy storage device and the power supply, the energy storage regulator including a current sensor and a voltage sensor; and
a logic-controlled regeneration regulator connected to the energy storage device and to a motor of the device, wherein the logic-controlled regulator is configured to control a feed-forward charge of the energy storage device to ensure that the energy storage device retains an optimal charge condition,
wherein only the energy storage device is configured to supply energy to the device.

17. The system of claim 16, further comprising:
a motor controller configured to control a motor of the device; and
a boost converter connected between the motor controller and the energy storage device, wherein the boost converter is configured to increase an output of the energy storage device to increase the power available to the motor.

18. The system of claim 16, wherein the regeneration regulator is configured to capture and regulate energy produced by the device when work is applied to the device, and
wherein the energy storage device is configured to be simultaneously charged from the power supply and from the regenerative energy regulator.

19. The system of claim 16, further comprising:
a motor controller configured to control a motor of the device; and
a motor regulator connected between a motor of the device and the energy storage device,
wherein the motor regulator is configured to maintain a voltage of the motor controller of the device and a bus voltage of the motor to prevent an over/under voltage of the motor controller and to exceed motor back electromotive force (EMF).

20. The system of claim 16, wherein the energy storage device is a first energy storage device among a plurality of energy storage devices of the system, and
wherein the plurality of energy storage devices are connected in series.
